(19) United States
(12) Patent Application Publication
(10) Pub. No.: US 2007/0164657 A1
(43) Pub. Date: Jul. 19, 2007

(54) Method of manufacturing electron emission device, electron emission device manufactured using the method, and backlight unit and electron emission display device employing electron emission device

(76) Inventors: Jeong-Hee Lee, Seongnam-si (KR); Shang-Hyeun Park, Boryeong-si (KR); Tae-Won Jeong, Seoul (KR); Jeong-Na Heo, Yongin-si (KR)

Correspondence Address: Robert E. Bushnell, Suite 300, 1522 K Street, N.W., Washington, DC, 20005, US

(21) Appl. No.: 11/522,317

(22) Filed: Sep. 18, 2006

(30) Foreign Application Priority Data
Jan. 14, 2006 (KR) 10-2006-0004169

(51) Int. Cl. H01J 63/04; H01J 1/62

(52) U.S. Cl. 313/497; 313/485; 313/495

(57) ABSTRACT

A method of manufacturing an electron emission device includes the steps of (a) forming a cathode electrode on a substrate, (b) forming an emitter on the cathode electrode by patterning, (c) forming a photosensitive glass paste layer burying the emitter by coating and drying the photosensitive paste layer on the surface of the substrate fabrication in which the emitter is formed, and (d) forming a gate insulating layer by patterning the result of step (c) by exposing, developing and calcining the photosensitive glass paste layer. The number of steps of the method of manufacturing an electron emission device is reduced and the processes are simplified due to self-alignment, and thus the manufacturing cost is reduced. The electron emission device is used as an electron emission type backlight unit and/or in an electron emission display device.

### CLAIM OF PRIORITY

This application makes reference to, incorporates the same herein, and claims all benefits accruing under 35 U.S.C.§119 from an application for METHOD OF MANUFACTURING ELECTRON EMISSION DEVICE, ELECTRON EMISSION DEVICE PREPARED USING THE METHOD, AND BACKLIGHT UNIT AND ELECTRON EMISSION DISPLAY DEVICE ADOPTING THE ELECTRON EMISSION DEVICE earlier filed in the Korean Intellectual Property Office on the 14^{th} of Jan. 2006 and there duly assigned Serial No. 10-2006-0004169.

### BACKGROUND OF THE INVENTION

1. Technical Field

The present invention relates to a method of manufacturing an electron emission device, an electron emission device manufactured using the method, a backlight unit, and an electron emission display device including the electron emission device. More particularly, the invention relates to a method of manufacturing an electron emission device, an electron emission device manufactured using the method, a backlight unit, and an electron emission display device including the electron emission device, wherein the manufacturing processes are simplified using a photosensitive glass paste.

2. Related Art

Generally, electron emission devices can be classified into electron emission devices using a thermionic cathode and electron emission devices using a cold cathode as an electron emission source. Electron emission devices which use a cold cathode as an electron emission source include field emitter array (FEA) type devices, surface conduction emitter (SCE) type devices, metal insulator metal (MIM) type devices, metal insulator semiconductor (MIS) type devices, ballistic electron surface emitting (BSE) type devices, etc.

A field emitter array (FEA) type electron emission device uses the principle that, when a material having a low work function or a high 13 function is used as an electron emission source, the material readily emits electrons in a vacuum due to an electric potential. FEA devices which employ a tapered tip structure formed of, for example, Mo or Si as a main component, or which use a carbon group material such as graphite, diamond-like carbon (DLC), etc., or a nano structure such as nanotubes, nano wires, etc., as an electron emission source have been developed.

In a surface conduction emitter (SCE) type electron emission device, an electron emission source includes a conductive thin film having a nano-size gap between first and second electrodes disposed parallel to each other on a substrate. The electron emission device makes use of the principle that electrons are emitted from micro cracks, which are electron emission sources, when a current flows on the surface of the conductive thin film as a result of a voltage being applied between the electrodes.

The metal insulator metal (MIM) and metal insulator semiconductor (MIS) type electron emission devices have a metal-dielectric layer-metal (MIM type) structure and a metal-dielectric layer-semiconductor (MIS type) structure, respectively, and make use of the principle that, when voltages are applied to two metals having a dielectric layer therebetween or to a metal and a semiconductor having a dielectric layer therebetween, electrons migrate from the metal or the semiconductor having a high electron potential to the metal having a low electron potential.

A ballistic electron surface emitting (BSE) type electron emission device includes an electron emission source making use of the principle that electrons travel without scattering when the size of a semiconductor is smaller than the mean-free-path of electrons in the semiconductor. To form the electron emission source, an electron supply layer formed of a metal or a semiconductor is formed on an ohmic electrode, and an insulating layer and a metal thin film are formed on the electron supply layer. When a voltage is applied between the ohmic electrode and the metal thin film, the electron emission source emits electrons.

The FEA type electron emission devices can be classified into top gate types and under gate types according to the arrangement of a cathode electrode and a gate electrode. FEAs can also be classified into two-electrode, three-electrode, or four-electrode type emission devices according to the number of electrodes.

The material forming electron emission sources of the above described electron emission devices include carbon group materials, for example, carbon nanotubes having good conductivity, good electric field concentration effect, a low work function, and good electron emission characteristics.

Since the discovery of carbon nanotubes in 1991, much research has been conducted to find ways of applying carbon nanotubes to electron emission. Generally, carbon group materials including carbon nanotubes are formed on a silicon or glass substrate.

A two-electrode carbon nanotube FED can be easily manufactured because no insulating layer or gate is needed as in the three-electrode structure. However, the simple two-electrode structure cannot easily control emitted electrons, and thus it is difficult to function well as a display device.

In addition, a three-electrode carbon nanotube FED using a glass substrate has not been completely realized yet. A three-electrode carbon nanotube FED is manufactured using a semiconductor process or a printing method, wherein a cathode and a gate electrode are formed in a matrix using a glass substrate. In this case, each element is difficult to maintain and apt to be damaged by overvoltage or overcurrent, and basically, it is difficult to manufacture a three-electrode carbon nanotube FED structure itself.

An electron emission device is manufactured in the following manner.

A cathode electrode is formed on a substrate. The cathode electrode is patterned by deposition of indium tin oxide (ITO) and photolithography. A gate insulating layer is formed on the cathode electrode. The gate insulating layer has through holes partially exposing the cathode electrode. The gate insulating layer may be formed using, for example, a screen printing method. A gate electrode is formed on the gate insulating layer. The gate electrode has gate holes corresponding to the through holes, and is formed by deposition and patterning of a metal by a thin layer forming process or a thick layer forming process, or by screen printing of a metal paste. However, the manufacturing cost of the conventional electron emission device is high when employing a thin layer process due to the use of expensive apparatuses, and the materials and processes of the thick layer process are not completely refined yet.

### SUMMARY OF THE INVENTION

The present invention provides a method of manufacturing an electron emission device, an electron emission device manufactured using the method, and a backlight unit and an electron emission display device employing the same, wherein the manufacturing processes are simplified and the manufacturing costs are reduced.

According to an aspect of the present invention, a method of manufacturing an electron emission device comprises: (a) forming a cathode electrode on a substrate; (b) forming an emitter on the cathode electrode by patterning; (c) forming a photosensitive glass paste layer burying the emitter by coating and drying the photosensitive glass paste layer on the surface of the substrate in which the emitter is formed; and (d) forming a gate insulating layer by patterning the result of (c) by exposing, developing and calcining the photosensitive glass paste layer.

The method preferably further comprises forming a gate electrode on the top surface of the gate insulating layer to form a three-electrode structure.

According to another aspect of the present invention, there is provided an electron emission device manufactured using the above described method.

According to another aspect of the present invention, an electron emission type backlight unit comprises: an upper substrate and a lower substrate which are disposed in parallel at a predetermined interval; an anode electrode formed on the upper substrate; a phosphor layer formed on the anode electrode to a predetermined thickness; and an electron emission device interposed between the upper substrate and the lower substrate.

According to another aspect of the present invention, an electron emission display device comprises: an upper substrate and a lower substrate disposed in parallel at a predetermined interval; an anode electrode formed on the upper substrate; a phosphor layer formed on the anode electrode to a predetermined thickness; and an electron emission device interposed between the upper substrate and the lower substrate.

According to the present invention, the number of the processes of the manufacturing method used to manufacture the electron emission device is reduced, and the processes are simplified due to self-alignment, and thus the manufacturing cost is reduced.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIGS. 1A thru 1E illustrate a method of manufacturing an electron emission device according to an embodiment of the present invention;

FIG. 2 is a perspective view of an electron emission device according to an embodiment of the present invention;

FIG. 3 is a cross-sectional view of FIG. 2 taken along line II-II of FIG. 2;

FIG. 4 is a photograph taken from above the three dimensional shape of the electron emission device before calcination according to the present invention;

FIG. 5 is a photograph taken from above the three dimensional shape of the electron emission device after calcination according to the present invention;

FIG. 6 is an SEM photograph after Tape S/T (stripping); and

FIG. 7 is a photograph of the electron emission device emitting light according to the present invention.

### DETAILED DESCRIPTION OF THE INVENTION

The present invention will now be described more fully with reference to the accompanying drawings, in which exemplary embodiments of the invention are shown.

The present invention provides a method of manufacturing an electron emission device, comprising: (a) forming a cathode electrode on a substrate; (b) forming an emitter on the cathode electrode by patterning; (c) forming a photosensitive glass paste layer which buries the emitter by coating and drying the photosensitive paste layer on the surface of the substrate fabrication in which the emitter is formed; and (d) forming a gate insulating layer by patterning the result of (c) by exposing, developing, and calcining the photosensitive glass paste layer.

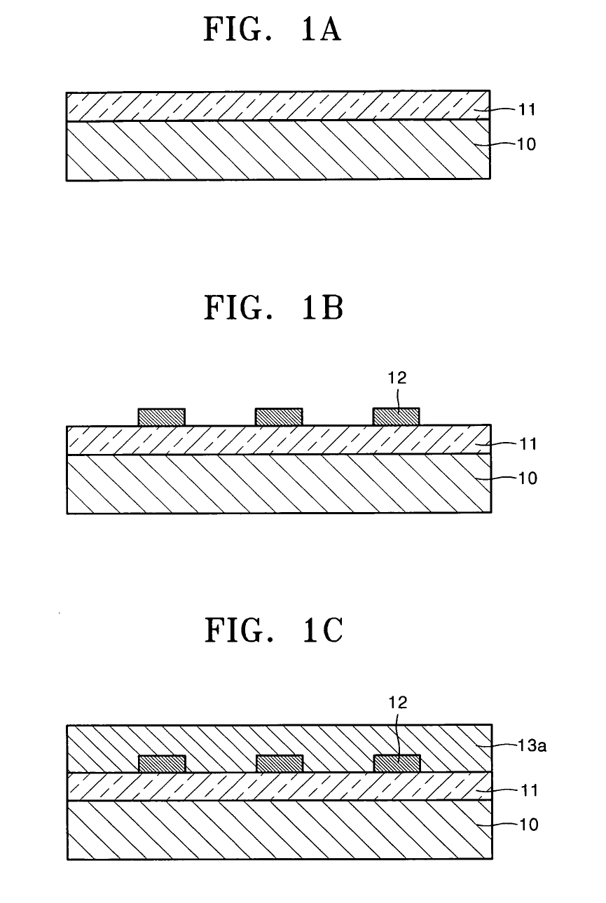

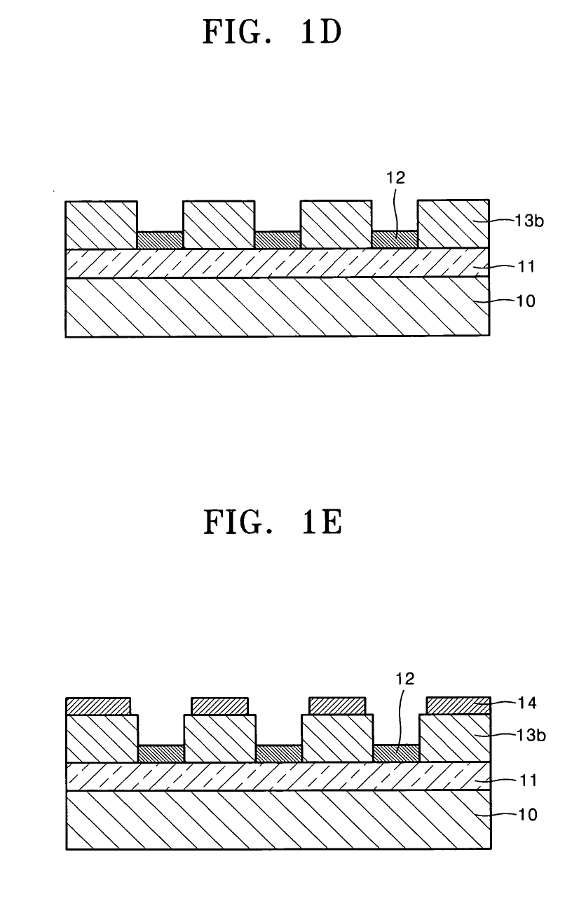

FIGS. 1A thru 1E illustrate the method of manufacturing an electron emission device according to an embodiment of the present invention. Hereinafter, the method of manufacturing an electron emission device according to the present invention will be described with reference to FIGS. 1A thru 1E.

As illustrated in FIG. 1A, a cathode electrode 11 is formed on a substrate 10. The substrate 10 may generally be a glass substrate. The cathode electrode 11 may be formed of a transparent conductive material, for example, indium tin oxide (ITO).

In detail, after a cathode electrode layer is deposited on the substrate 10, the cathode electrode layer is patterned in a predetermined arrangement, for example, in a line, so as to form the cathode electrode 11. The shape of the cathode electrode 11 is preferably a line.

As illustrated in FIG. 1B, an emitter material is stacked on the cathode electrode 11 to form an emitter layer. The emitter layer is preferably a carbon nanotube emitter. The carbon nanotube can be stacked on the cathode electrode 11 using two methods. That is, pasty carbon nanotubes may be coated on the cathode electrode 11, or carbon nanotubes may be grown on the cathode electrode 11 using a chemical vapor deposition (CVD) technique. When a carbon nanotube paste is coated on the cathode electrode 11, both a single wall nanotube (SWNT) and a multi wall nanotube (MWNT) may be used.

After the emitter layer is formed on the cathode electrode 1, the emitter layer is patterned to a desired pattern so as to form emitters 12. The patterning can be performed using a well known technique in the art, and may be, for example, as follows.

A mask (not shown) is aligned under the substrate 10 and ultraviolet (UV) light is radiated toward the substrate 10. A pattern corresponding to the desired emitter pattern is formed in the mask in advance. Accordingly, when UV light is radiated through the mask, the emitter layer is sensitized according to the pattern of the mask. Finally, when the emitter layer is washed using, for example, acetone, the emitter 12 for an electron device as illustrated in FIG. 1B is completed.

As illustrated in FIG. 1C, a photosensitive glass paste 13a is coated on the surface of the substrate fabrication in which the emitter 12 is formed so as to bury the emitter 12. Then, the resultant structure is dried, and a backside of the resultant structure is exposed. Thus, the photosensitive glass paste in the upper portion of the emitter remains as an unexposed area, and the rest of the photosensitive glass paste is an exposed area. The exposure is preferably performed at an intensity of 200-500 mJ/cm².

The photosensitive glass paste is a pasty composition including glass powder, a photosensitive resin, and a solvent.

Examples of the glass powder include \textcircled{1} lead oxide, boron oxide, silicon oxide, calcium oxide (PbO—B₂O₃—SiO₂—CaO-based), \textcircled{2} zinc oxide, boron oxide, silicon oxide (ZnO—B₂O₃—SiO₂-based), \textcircled{3} lead oxide, boron oxide, silicon oxide, aluminium oxide (PbO—B₂O₃—SiO₂—Al₂O₃-based), \textcircled{4} lead oxide, zinc oxide, boron oxide, silicon oxide (PbO—ZnO—B₂O₃—SiO₂), and \textcircled{5} lead oxide, zinc oxide, boron oxide, silicon oxide, titanium oxide (PbO—ZnO—B₂O₃—SiO₂—TiO₂-based). An, inorganic oxide compound powder, such as aluminum oxide, chromium oxide, manganese oxide, etc., may be used by mixing it with the glass powder.

The photosensitive resin is used for patterning of electron emission sources, and examples thereof include, but are not limited to, an acrylate monomer having a thermal decomposition property, a benzophenone-based monomer, an acetphenone-based monomer, and a tioxantone-based monomer, and in detail, epoxy acrylate, polyester acrylate, 2,4-diethyloxanthone, and 2,2-dimethoxy-2-phenylacetophenone.

The amount of the photosensitive material may be 3 to 7 parts by weight based on 100 parts by weight of the glass powder. If the amount of the photosensitive resin is less than 3 parts by weight based on 100 parts by weight of the glass powder, the exposure sensitivity thereof is low. If the amount of the photosensitive resin is over 7 parts by weight, developing of the photosensitive resin is not easy.

Examples of the solvent include butyl carbitole acetate (BCA), terpineol (TP), toluene, texanol, and butyl carbitol (BC). The material from which the solvent is made can be used alone or in a combination of two or more materials. The amount ratio of the solvent in the composition of the present invention may be 10 to 20 parts by weight to 100 parts by weight of the glass powder in order to maintain an appropriate viscosity of the paste composition. The printing process can be performed efficiently by adjusting the amount of the solvent.

The photosensitive glass paste in the present invention may further include one or more additives selected from the group consisting of a photoinitiator, a thickener, a resolution improving agent, a dispersant, and an antifoaming agent. The photoinitiator initiates the cross linkage of the photosensitive resin when the photosensitive resin is exposed to light. An example of the photoinitiator is benzophenone, but it is not limited thereto.

After the result of FIG. 1C is exposed, and then developed, an unexposed portion of the upper portion of the emitter layer is removed, and is calcined and hardened at 450-500° C. to form a gate insulating layer 13b as illustrated in FIG. 1D.

According to the method of manufacturing an electron emission device of the present invention, a step of forming a gate electrode on the upper surface of the gate insulating layer is further included, and thus a three-electrode structure can be formed. As illustrated in FIG. 1E, a gate electrode 14 is formed on the gate insulating layer 13b. The gate electrode 14 may have gate holes corresponding to the through holes in the upper portion of the emitter 12, and may be formed by deposition or patterning of a metal, the so-called thin layer process, or a screen printing method of metal paste, which is also called a thick layer process.

The present invention also provides an electron emission device manufactured by the above described method.

The electron emission device can be used as a backlight unit for various electronic devices, such as a liquid crystal display (LCD) or an electron emission display device.

The backlight unit includes an upper substrate and a lower substrate which are disposed in parallel at a predetermined interval, an anode electrode formed on the upper substrate, a phosphor layer formed on the anode electrode to a predetermined thickness, and an electron emission device interposed between the upper substrate and the lower substrate.

The operation of the backlight unit is as follows. First, when a predetermined voltage is applied to the gate electrode and another predetermined voltage is applied to the anode electrode, electrons are emitted from the emitter. The emitted electrons proceed toward the anode electrode, and collide with the phosphor layer. In this regard, visible rays are emitted from the phosphor layer, and the visible rays pass through the upper substrate and/or the lower substrate.

The electron emission display device includes an upper substrate and a lower substrate disposed in parallel at a predetermined interval, an anode electrode formed on the upper substrate, a phosphor layer formed on the anode electrode to a predetermined thickness, and an electron emission device interposed between the upper substrate and the lower substrate.

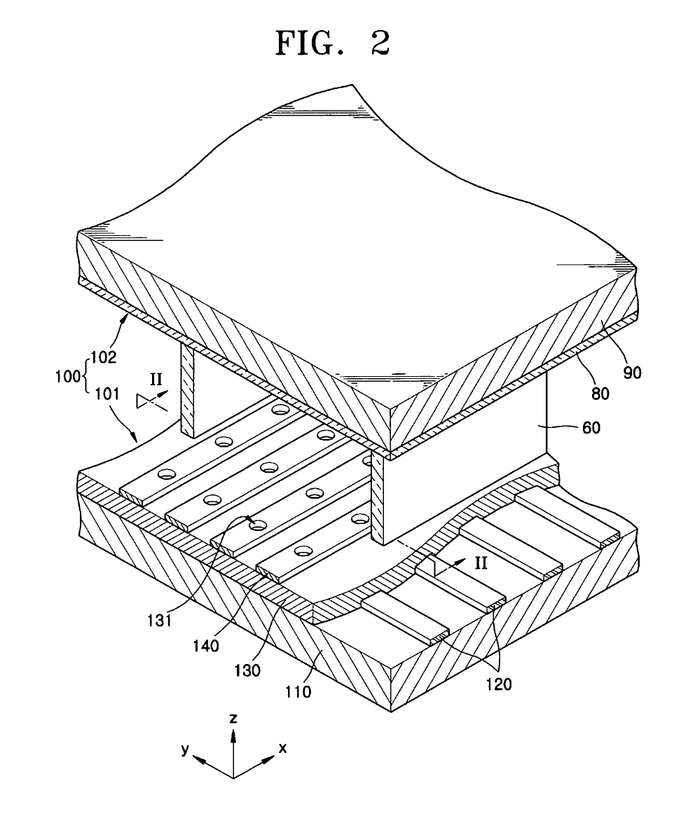

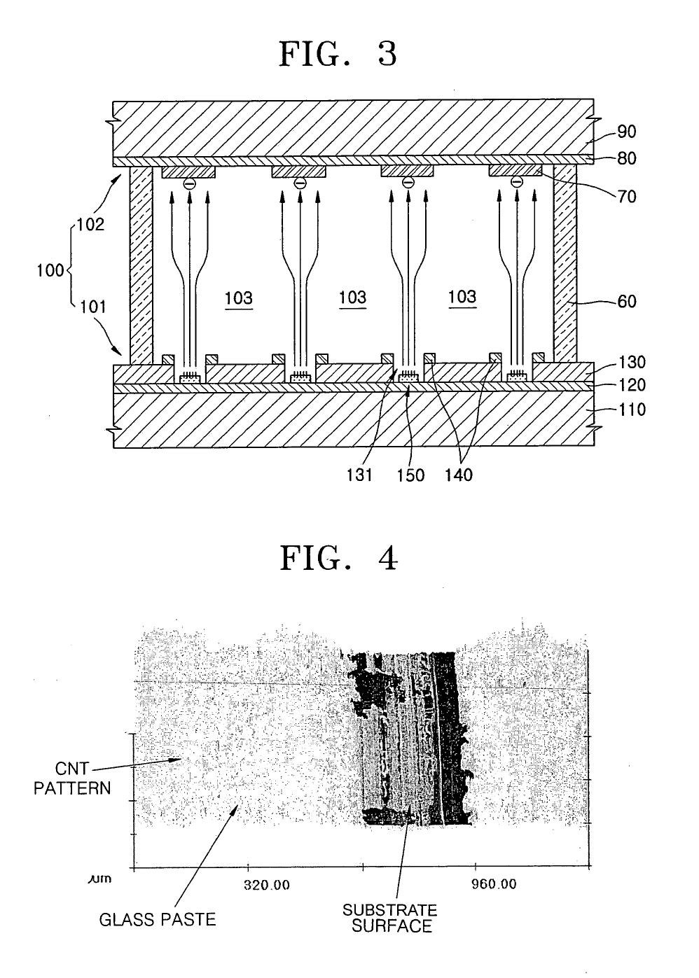

FIG. 2 is a partial perspective illustrating a top gate type electron emission display device, and FIG. 3 is a cross-sectional view of FIG. 2 taken along a line II-II of FIG. 2.

As illustrated in FIGS. 2 and 3, the electron emission display device 100 includes an electron emission device 101 according to the present invention and a front panel 102 which are disposed in parallel and which form a vacuum light emitting space 103, and a spacer 60 which maintains an interval between the electron emission device 101 and the front panel 102.

The electron emission device 101 includes a first substrate 110, gate electrodes 140 and cathode electrodes 120 which are formed on the first substrate 110 so as to cross each other, and an insulating layer 130 disposed between the gate electrodes 140 and the cathode electrodes 120 so as to provide electrical insulation between the gate electrode 140 and the cathode electrode 120.

Electron emission source holes 131 are formed in the areas where the gate electrodes 140 and the cathode electrodes 120 cross each other, and electron emission sources 150 are disposed in the holes 131.

The front panel 102 includes a second substrate 90, an anode electrode 80 disposed on the lower surface of the second substrate 90, and a phosphor layer 70 disposed on the lower surface of the anode electrode 80.

The electron emission display device according to the present invention is described with reference to FIGS. 2 and 3, but various examples such as an electron emission display device, including a second insulating layer and/or a focusing electrode, are also possible.

Hereinafter, the present invention will be described in more detail with reference to the following examples. However, these examples are intended to limit the scope of the invention.

### EXAMPLE 1

1 g of CNT powder (CNT, SWNT), 25 g of polyester acrylate which is an acryl resin, 2 g of photoinitiator HSP 188 (available from SK UCB Co., Ltd.), and 6 g of Petia which is a photosensitive polymer are added to 40 g of terpineol, and are agitated to manufacture a pasty composition for forming electron emission sources having a viscosity of 30,000 cps.

An ITO cathode electrode was patterned in lines on a glass substrate, and the composition for forming electron emission sources was coated thereon. Then, an exposure energy of 1000 mJ/cm² was irradiated thereto using a parallel exposure system. The result was then developed with acetone to form a composition for forming electron emission sources in the electron emission source forming area.

The resultant was coated with a photosensitive glass paste composition, and was dried to form a photosensitive glass paste layer. Then, exposure energy of 300 mJ/cm² was irradiated thereto from the rear surface of the substrate. Carbonate sodium salt was used as an alkali developing agent, and was treated with heat at 500° C. and under air atmosphere to form a gate insulating layer.

A gate electrode was formed on the gate insulating layer to form an electron emission device. The material forming the gate electrode may be, for example, chromium.

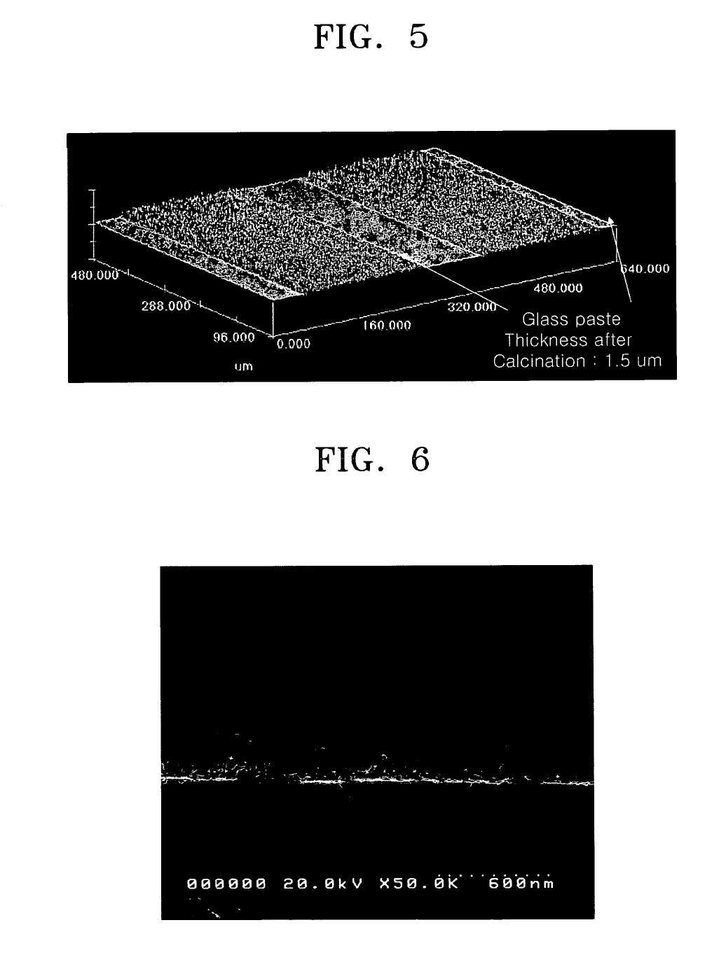

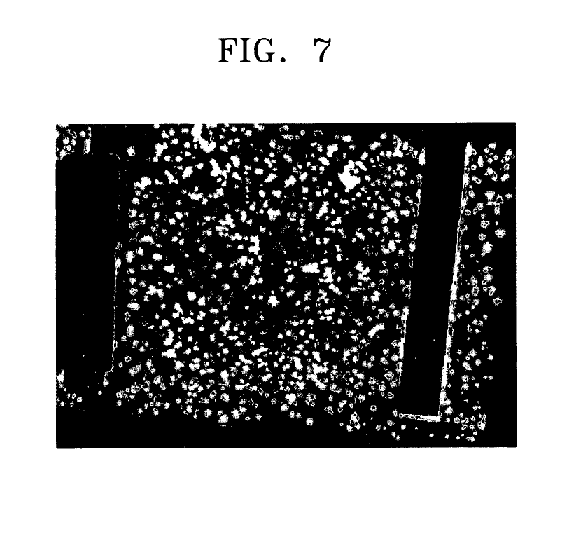

FIG. 4 is a photograph taken from above of a three-dimensional shape of an electron emission device manufactured according to the present invention before calcination; FIG. 5 is a photograph taken from above of a three-dimensional shape of an electron emission device manufactured according to the present invention after calcination; FIG. 6 is an SEM photograph after Tape S/T (surface treatment); and FIG. 7 is a photograph of the electron emission device emitting light, wherein the electron emission device was manufactured according to the present invention.

According to the present invention, the number of processes of the manufacturing method of an electron emission device is reduced, and the processes are simplified due to self-alignment, and thus the manufacturing cost is reduced.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A method of manufacturing an electron emission device, comprising the steps of:
(a) forming a cathode electrode on a substrate;
(b) forming an emitter on the cathode electrode by patterning;
(c) forming a photosensitive glass paste layer burying the emitter by coating and drying the photosensitive glass paste layer on a surface in which the emitter is formed; and
(d) forming a gate insulating layer by patterning the result of step (c) by exposing, developing and calcining the photosensitive glass paste layer.

2. The method of claim 1, wherein the cathode electrode is patterned in lines parallel to the substrate.

3. The method of claim 1, wherein the emitter is a carbon nanotube emitter.

4. The method of claim 1, further comprising the step of forming a gate electrode on a top surface of the gate insulating layer to form a three-electrode structure.

5. An electron emission device manufactured using the method of claim 1.

6. An electron emission type backlight unit comprising an electron emission device manufactured using the method of claim 1, said electron emission type backlight unit further comprising:
an upper substrate and a lower substrate disposed in parallel at a predetermined interval;
an anode electrode formed on the upper substrate; and
a phosphor layer formed on the anode electrode to a predetermined thickness;
said electron emission device being interposed between the upper substrate and the lower substrate.

7. An electron emission display device comprising an electron emission device manufactured using the method of claim 1, said electron emission display device further comprising:
an upper substrate and a lower substrate disposed in parallel at a predetermined interval;
an anode electrode formed on the upper substrate; and
a phosphor layer formed on the anode electrode to a predetermined thickness;
said electron emission device being interposed between the upper substrate and the lower substrate.

8. An electron emission type backlight unit, comprising:
an upper substrate and a lower substrate disposed in parallel at a predetermined interval;
an anode electrode formed on the upper substrate;
a phosphor layer formed on the anode electrode to a predetermined thickness; and
an electron emission device interposed between the upper substrate and the lower substrate;
wherein the electron emission device comprises a cathode electrode formed on a substrate, an emitter formed by patterning on the cathode electrode, a photosensitive glass paste layer burying the emitter, and a gate insulating layer formed by patterning the photosensitive glass paste layer.

9. An electron emission display device, comprising:
an upper substrate and a lower substrate disposed in parallel at a predetermined interval;
an anode electrode formed on the upper substrate;
a phosphor layer formed on the anode electrode to a predetermined thickness; and
an electron emission device interposed between the upper substrate and the lower substrate;
wherein the electron emission device comprises a cathode electrode formed on a substrate, an emitter formed by patterning on the cathode electrode, a photosensitive glass paste layer burying the emitter, and a gate insulating layer formed by patterning the photosensitive glass paste layer.
